(19) United States
(12) Patent Application Publication
(10) Pub. No.: US 2025/0196255 A1
(43) Pub. Date: Jun. 19, 2025

(54) LASER CLEANING METHOD FOR MULTIPLE TABS

(71) Applicant: HYMSON LASER TECHNOLOGY GROUP CO., LTD., Shenzhen (CN)

(72) Inventors: Rong ZHANG, Shenzhen (CN); Shuhong LUO, Shenzhen (CN); Yuhuai YANG, Shenzhen (CN); Yu LIN, Shenzhen (CN); Peng WU, Shenzhen (CN); Yong MA, Shenzhen (CN); Shuyang ZHAO, Shenzhen (CN)

(73) Assignee: HYMSON LASER TECHNOLOGY GROUP CO., LTD., Shenzhen (CN)

(21) Appl. No.: 18/792,339

(22) Filed: Aug. 1, 2024

Related U.S. Application Data
(63) Continuation of application No. PCT/CN2024/074641, filed on Jan. 30, 2024.

(30) Foreign Application Priority Data
Dec. 14, 2023 (CN) 202311729977.2

(51) Int. Cl. B23K 26/042; B23K 26/03; B23K 26/06; B23K 26/36; B23K 26/70; B23K 101/18; B23K 101/36

(52) U.S. Cl. CPC B23K 26/042; B23K 26/032; B23K 26/0643; B23K 26/36; B23K 26/702; B23K 2101/18; B23K 2101/36

(57) ABSTRACT

A laser cleaning method for multiple tabs includes: performing a parallelism correction of each galvanometer to be spliced relative to a processing platform; splicing multiple galvanometers into a galvanometer array, performing parallelism calibration between adjacent galvanometers in the galvanometer array; performing a distortion correction on a single frame produced by each galvanometer; splicing multiple single frames corresponding to multiple galvanometers into an entire frame corresponding to the galvanometer array; normalizing a single frame coordinate system corresponding to each single frame into an entire frame coordinate system corresponding to the entire frame; obtaining offset information of a material strip edge of a material strip passing through a laser cleaning device relative to a material strip travel direction, and performing offset compensation on the galvanometer array based on the offset information; and performing laser cleaning simultaneously on multiple tabs on a pole piece by the galvanometer array.

### CROSS-REFERENCE TO RELATED APPLICATIONS

This application is a continuation application of International Application No. PCT/CN2024/074641, filed on Jan. 30, 2024, which claims priority to Chinese Patent Application No. 202311729977.2, filed on Dec. 14, 2023. The disclosures of the above-mentioned applications are incorporated herein by reference in their entireties.

### TECHNICAL FIELD

The present application relates to the field of laser cleaning, and in particular to a laser cleaning method for multiple tabs.

### BACKGROUND

In the lithium battery production process, a laser cleaning process for tabs is involved. Laser cleaning for tabs usually involves cleaning the surface coating layer of the pole piece to expose the substrate, and then cutting out the cleaning area by die cutting to serve as the tabs of the battery.

Among the current laser cleaning methods for tabs, one method is to use a single laser to clean a narrow tab, which has a low cleaning efficiency, and the other method is to use multiple galvanometers to clean multiple tabs with a wider frame, but the precision control during the cleaning process is poor.

### SUMMARY

The present application provides a laser cleaning method for multiple tabs, which improves the laser cleaning control accuracy when realizing laser cleaning for multiple tabs simultaneously on a wider frame.

The embodiment of the present application provides a laser cleaning method for multiple tabs, including: performing a parallelism correction of each galvanometer to be spliced relative to a processing platform, so that the each galvanometer meets a first error requirement; splicing multiple galvanometers into a galvanometer array, performing parallelism calibration between adjacent galvanometers in the galvanometer array, so that the adjacent galvanometers tend to be located on a same horizontal plane and meet a second error requirement; performing a distortion correction on a single frame produced by the each galvanometer, so that the single frame corresponding to the each galvanometer meets a third error requirement; splicing multiple single frames corresponding to the multiple galvanometers into an entire frame corresponding to the galvanometer array, adjacent single frames are parallel to each other and have overlapping edges; normalizing a single frame coordinate system corresponding to each single frame into an entire frame coordinate system corresponding to the entire frame; obtaining offset information of a material strip edge of a material strip passing through a laser cleaning device relative to a material strip travel direction, and performing offset compensation on the galvanometer array based on the offset information; and performing laser cleaning simultaneously on multiple tabs on a pole piece by the galvanometer array.

According to any of the aforementioned embodiments of the present application, the performing the parallelism correction of the each galvanometer to be spliced relative to the processing platform, so that the each galvanometer meets the first error requirement includes: obtaining a focal height of a field mirror; and utilizing a length measuring instrument to adjust a pitch angle of the galvanometer based on the focal height of the field mirror, so that the galvanometer tends to be parallel to a table top of a processing platform of the laser cleaning device.

According to the aforementioned embodiment of the present application, the first error requirement is taken within a range below 0.03 mm.

According to the aforementioned embodiment of the present application, the second error requirement is taken within a range below 0.05 mm.

According to the aforementioned embodiment of the present application, the performing the distortion correction on the single frame produced by the each galvanometer, so that the single frame corresponding to the each galvanometer meets the third error requirement includes: performing a high-precision corrections on the each galvanometer multiple times until the single frame corresponding to the galvanometer meets the third error requirement.

According to the aforementioned embodiment of the present application, the high-precision calibration every time includes: adopting a two-dimensional imager to evenly divide the each single frame into several equal parts, and generating theoretical coordinate positions corresponding to multiple segmentation points; marking each segmentation point on a photographic paper by laser of the galvanometer, and utilizing the two-dimensional imager to identify an actual coordinate position corresponding to the each segmentation point; and comparing the actual coordinate position of the each segmentation point with a theoretical coordinate position of the each segmentation point, obtaining a comparison difference, and performing position compensation on the galvanometer based on the comparison difference.

According to any of the aforementioned embodiments of the present application, the single frame corresponding to the galvanometer meets the third error requirement includes: a difference between the actual coordinate position of the each segmentation point and the theoretical coordinate position of the each segmentation point is less than 0.03 mm.

According to any of the aforementioned embodiments of the present application, the splicing the multiple single frames corresponding to the multiple galvanometers into the entire frame corresponding to the galvanometer array includes: starting from a first single frame and a second single frame, taking a former single frame of each adjacent two single frames as a reference, performing frame translation and frame rotation on a latter single frame, so that the latter single frame and the former single frame are parallel and have the overlapping edges.

According to any of the aforementioned embodiments of the present application, the normalizing the single frame coordinate system corresponding to the each single frame into the entire frame coordinate system corresponding to the entire frame includes: making two coordinate axes of the single frame coordinate system corresponding to the each single frame correspond and overlap with each other.

According to any of the aforementioned embodiments of the present application, the laser cleaning device is provided with edge-finding sensors at a front side of a laser cleaning station and a rear side of the laser cleaning station, and the obtaining the offset information of the material strip edge of the material strip passing through the laser cleaning device relative to the material strip travel direction includes: obtaining a front side deviation amount of the material strip edge at the front side of the laser cleaning station and a rear side deviation amount of the material strip edge at the rear side of the laser cleaning station respectively by the edge-finding sensors at the front side of the laser cleaning station and the rear side of the laser cleaning station; and obtaining the offset information based on the front side deviation amount and the rear side deviation amount.

The laser cleaning method for multiple tabs according to the embodiment of the present application, on the one hand, performing a parallelism correction of each galvanometer to be spliced relative to a processing platform; then, performing parallelism calibration between adjacent galvanometers in the galvanometer array; and then performing a distortion correction on a single frame produced by each galvanometer; after splicing multiple single frames corresponding to multiple galvanometers into an entire frame corresponding to the galvanometer array, adjacent single frames are parallel to each other and have overlapping edges; then, obtaining offset information of a material strip edge of a material strip passing through a laser cleaning device relative to a material strip travel direction, and performing offset compensation on the galvanometer array based on the offset information; so that, subsequently, when performing laser cleaning simultaneously on multiple tabs on a pole piece by the galvanometer array, the control accuracy of the galvanometer array is improved while ensuring a larger and wider cleaning frame, thereby improving the laser cleaning effect. On the other hand, after splicing multiple single frames corresponding to multiple galvanometers into an entire frame corresponding to the galvanometer array, normalizing a single frame coordinate system corresponding to each single frame into an entire frame coordinate system corresponding to the entire frame. Therefore, any point on the entire frame can be retrieved without adjustment in the single frame, which is convenient for controlling multiple laser modules simultaneously by an upper computer, which can greatly save signal transmission time and further improve the efficiency of cleaning work.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is a flow chart of a laser cleaning method for multiple tabs according to an embodiment of the present application.

FIG. 2 is a structural schematic view that after performing a horizontal correction on a galvanometer in an embodiment of a laser cleaning method for multiple tabs of the present application.

FIG. 3 is a structural schematic view that before splicing a single frame in an embodiment of a laser cleaning method for multiple tabs of the present application.

FIG. 4 is a structural schematic view that after splicing a single frame in an embodiment of a laser cleaning method for multiple tabs of the present application.

FIG. 5 is a structural schematic view of a material strip edge of a material strip passing through a laser cleaning device in an embodiment of a laser cleaning method for multiple tabs of the present application.

FIG. 6 is a structural schematic view that obtaining offset information of a material strip edge of a material strip passing through a laser cleaning device relative to a material strip travel direction in an embodiment of a laser cleaning method for multiple tabs of the present application.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that in the embodiment of the present application, all directional indications (such as up, down, left, right, front, back or the like) are only used to explain the relative positional relationship, movement and so on between various components in a specific posture (as shown in the accompanying drawings). If the specific posture changes, the directional indication will also change accordingly.

In addition, the descriptions that involving “first”, “second” or the like in the present application are only for descriptive purposes and cannot be understood as indicating or implying the relative importance or implicitly indicating the quantity of the technical features indicated. Therefore, features defined as “first” and “second” may explicitly or implicitly include at least one of these features. In addition, the technical solutions of various embodiments can be combined with each other, but it is based on that those skilled in the art can realize. When the combination of technical solutions is contradictory or cannot be realized, it should be considered that such combination of technical solutions does not exist and is not within the protection scope claimed by the present application.

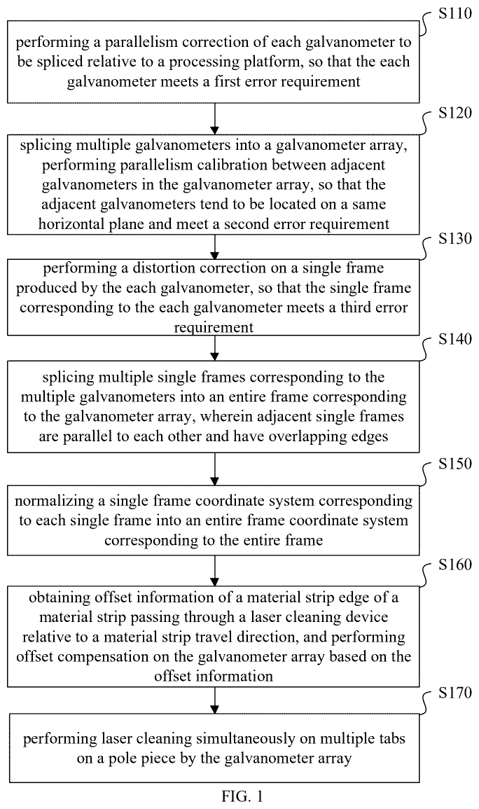

FIG. 1 is a flow chart of a laser cleaning method for multiple tabs according to an embodiment of the present application. In this embodiment, the laser cleaning method for multiple tabs includes steps S110 to S170.

In step S110, performing a parallelism correction of each galvanometer to be spliced relative to a processing platform, so that each galvanometer meets a first error requirement.

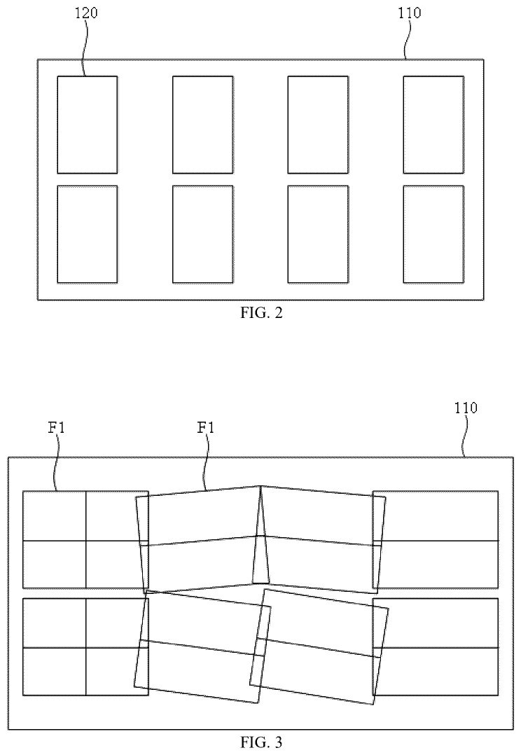

FIG. 2 is a structural schematic view that after performing a horizontal correction on a galvanometer in an embodiment of a laser cleaning method for multiple tabs of the present application

In some embodiments, the first error requirement is taken within a range below 0.03 mm.

In some embodiments, the performing the parallelism correction of each galvanometer to be spliced relative to the processing platform, so that each galvanometer meets the first error requirement includes: obtaining a focal height of a field mirror; and utilizing a length measuring instrument to adjust a pitch angle of the galvanometer based on the focal height of the field mirror, so that the galvanometer tends to be parallel to a table top of a processing platform of the laser cleaning device.

The length measuring instrument is, for example, a dial indicator, a micrometer, etc.

In step S120, splicing multiple galvanometers into a galvanometer array, performing parallelism calibration between adjacent galvanometers in the galvanometer array, so that the adjacent galvanometers tend to be located on a same horizontal plane and meet a second error requirement.

In some embodiments, the second error requirement is taken within a range below 0.05 mm. In an embodiment, the second error requirement is 0.03 mm. In another embodiment, the second error requirement is 0.05 mm.

By performing the parallelism correction of each galvanometer to be spliced relative to the processing platform and performing the parallelism correction between adjacent galvanometers of the galvanometer array, mechanical correction of multiple galvanometers 120 can be achieved.

As shown in FIG. 1, in step S130, performing a distortion correction on a single frame produced by each galvanometer, so that the single frame corresponding to each galvanometer meets a third error requirement.

In some embodiments, the step S130 of the performing the distortion correction on the single frame produced by each galvanometer 120, so that the single frame corresponding to each galvanometer 120 meets the third error requirement includes: performing a high-precision corrections on each galvanometer 120 multiple times until the single frame corresponding to the galvanometer 120 meets the third error requirement.

In some embodiments, high-precision calibration every time includes:

adopting a two-dimensional imager to evenly divide each single frame into several equal parts, and generating theoretical coordinate positions corresponding to multiple segmentation points; marking each segmentation point on a photographic paper by laser of the galvanometer 120, and utilizing the two-dimensional imager to identify an actual coordinate position corresponding to each segmentation point; and comparing the actual coordinate position of each segmentation point with a theoretical coordinate position of each segmentation point, obtaining a comparison difference, and performing position compensation on the galvanometer 120 based on the comparison difference.

In some embodiments, the single frame corresponding to the galvanometer 120 meets the third error requirement includes: a difference between the actual coordinate position of each segmentation point and the theoretical coordinate position of each segmentation point is less than 0.05 mm.

Usually, each galvanometer 120 needs to undergo the high-precision correction with three-time superposition, which can reduce the error to less than 0.03 mm. If the third error requirement of 0.03 mm is still not reached after three-time corrections, a fourth high-precision correction can be performed.

The purpose of the above-mentioned distortion correction is to eliminate the distortion (such as parallelograms, curved edges, etc.) generated in a single frame, so that the theoretical coordinates in a single frame correspond to the actual coordinates.

As shown in FIG. 1, in step S140, splicing multiple single frames corresponding to multiple galvanometers into an entire frame corresponding to the galvanometer array. Adjacent single frames are parallel to each other and have overlapping edges.

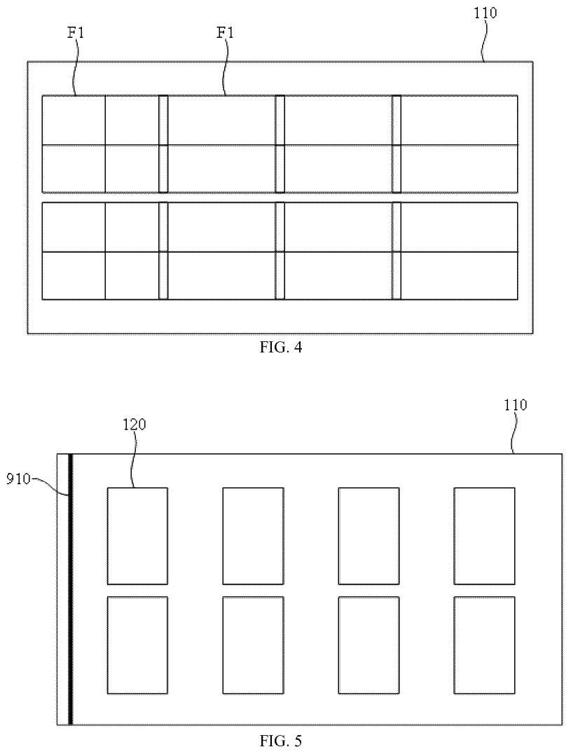

FIG. 3 and FIG. 4 are structural schematic views that before and after splicing a single frame in an embodiment of a laser cleaning method for multiple tabs of the present application.

In some embodiments, the step S140 of the splicing the multiple single frames F1 corresponding to the multiple galvanometers 120 into the entire frame corresponding to the galvanometer 120 array includes: starting from a first single frame F1 and a second single frame F1, taking a former single frame F1 of each adjacent two single frames F1 as a reference, performing frame translation and frame rotation on a latter single frame F1, so that the latter single frame F1 and the former single frame F1 are parallel and have the overlapping edges.

In step S150, normalizing a single frame coordinate system corresponding to each single frame F1 into an entire frame coordinate system corresponding to the entire frame

In some embodiments, the above-mentioned normalizing the single frame coordinate system corresponding to each single frame F1 into the entire frame coordinate system corresponding to the entire frame includes: making two coordinate axes of the single frame coordinate system corresponding to each single frame F1 correspond and overlap with each other.

At this time, any point on the entire frame can be retrieved without adjustment in the single frame F1, which is convenient for controlling multiple laser modules simultaneously by an upper computer, which can greatly save signal transmission time and further improve the efficiency of cleaning work.

FIG. 5 is a structural schematic view of a material strip edge of a material strip passing through a laser cleaning device in an embodiment of a laser cleaning method for multiple tabs of the present application.

In step S160, obtaining offset information of a material strip edge 910 of a material strip 900 passing through a laser cleaning device relative to a material strip travel direction, and performing offset compensation on the galvanometer array based on the offset information.

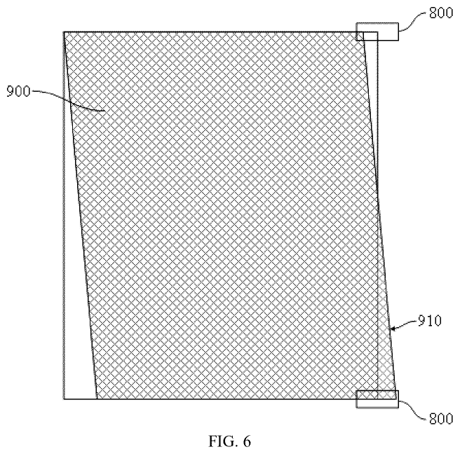

FIG. 6 is a structural schematic view that obtaining offset information of a material strip edge of a material strip passing through a laser cleaning device relative to a material strip travel direction in an embodiment of a laser cleaning method for multiple tabs of the present application. In some embodiments, the laser cleaning device is provided with edge-finding sensors 800 at a front side of a laser cleaning station and a rear side of the laser cleaning station. The above-mentioned step of obtaining the offset information of the material strip edge 910 of the material strip 900 passing through the laser cleaning device relative to the material strip travel direction may include: obtaining a front side deviation amount of the material strip edge 910 at the front side of the laser cleaning station and a rear side deviation amount of the material strip edge 910 at the rear side of the laser cleaning station respectively by the edge-finding sensors 800 at the front side of the laser cleaning station and the rear side of the laser cleaning station; and obtaining the offset information based on the front side deviation amount and the rear side deviation amount.

As shown in FIG. 1, in step S170, performing laser cleaning simultaneously on multiple tabs on a pole piece by the galvanometer array.

The laser cleaning method for multiple tabs according to the embodiment of the present application, on the one hand, performing a parallelism correction of each galvanometer 120 to be spliced relative to a processing platform 110; then, performing parallelism calibration between adjacent galvanometers 120 in the galvanometer array; and then performing a distortion correction on a single frame F1 produced by each galvanometer 120; after splicing multiple single frames F1 corresponding to multiple galvanometers 120 into an entire frame corresponding to the galvanometer array, adjacent single frames F1 are parallel to each other and have overlapping edges; then, obtaining offset information of a material strip edge 910 of a material strip 900 passing through a laser cleaning device relative to a material strip travel direction, and performing offset compensation on the galvanometer array based on the offset information; so that, subsequently, when performing laser cleaning simultaneously on multiple tabs on a pole piece by the galvanometer array, the control accuracy of the galvanometer array is improved while ensuring a larger and wider cleaning frame, thereby improving the laser cleaning effect. On the other hand, after splicing multiple single frames F1 corresponding to multiple galvanometers 120 into an entire frame corresponding to the galvanometer array, normalizing a single frame coordinate system corresponding to each single frame F1 into an entire frame coordinate system corresponding to the entire frame. Therefore, any point on the entire frame can be retrieved without adjustment in the single frame F1, which is convenient for controlling multiple laser modules simultaneously by an upper computer, which can greatly save signal transmission time and further improve the efficiency of cleaning work.

The laser cleaning method for multiple tabs according to the embodiment of the present application, array splicing of multiple galvanometers 120 can be realized. In an embodiment, eight galvanometers 120 are spliced into a galvanometer array. In another embodiment, sixteen galvanometers 120 are spliced into a galvanometer array. This ensures that the number of lasers completing the splicing is large enough and the corresponding entire frame range is large enough. Ultimately, the cleaning of tabs at any position can be covered within one frame.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A laser cleaning method for multiple tabs, comprising:
performing a parallelism correction of each galvanometer to be spliced relative to a processing platform, so that the each galvanometer meets a first error requirement;
splicing multiple galvanometers into a galvanometer array, performing parallelism calibration between adjacent galvanometers in the galvanometer array, so that the adjacent galvanometers tend to be located on a same horizontal plane and meet a second error requirement;
performing a distortion correction on a single frame produced by the each galvanometer, so that the single frame corresponding to the each galvanometer meets a third error requirement;
splicing multiple single frames corresponding to the multiple galvanometers into an entire frame corresponding to the galvanometer array, wherein adjacent single frames are parallel to each other and have overlapping edges;
normalizing a single frame coordinate system corresponding to each single frame into an entire frame coordinate system corresponding to the entire frame;
obtaining offset information of a material strip edge of a material strip passing through a laser cleaning device relative to a material strip travel direction, and performing offset compensation on the galvanometer array based on the offset information; and
performing laser cleaning simultaneously on multiple tabs on a pole piece by the galvanometer array.

2. The laser cleaning method for multiple tabs according to claim 1, wherein the performing the parallelism correction of the each galvanometer to be spliced relative to the processing platform, so that the each galvanometer meets the first error requirement comprises:
obtaining a focal height of a field mirror; and
utilizing a length measuring instrument to adjust a pitch angle of the galvanometer based on the focal height of the field mirror, so that the galvanometer tends to be parallel to a table top of a processing platform of the laser cleaning device.

3. The laser cleaning method for multiple tabs according to claim 1, wherein the first error requirement is taken within a range below 0.03 mm.

4. The laser cleaning method for multiple tabs according to claim 1, wherein the second error requirement is taken within a range below 0.05 mm.

5. The laser cleaning method for multiple tabs according to claim 1, wherein the performing the distortion correction on the single frame produced by the each galvanometer, so that the single frame corresponding to the each galvanometer meets the third error requirement comprises:
performing a high-precision corrections on the each galvanometer multiple times until the single frame corresponding to the galvanometer meets the third error requirement.

6. The laser cleaning method for multiple tabs according to claim 5, wherein the high-precision calibration every time comprises:
adopting a two-dimensional imager to evenly divide the each single frame into several equal parts, and generating theoretical coordinate positions corresponding to multiple segmentation points;
marking each segmentation point on a photographic paper by laser of the galvanometer, and utilizing the two-dimensional imager to identify an actual coordinate position corresponding to the each segmentation point; and
comparing the actual coordinate position of the each segmentation point with a theoretical coordinate position of the each segmentation point, obtaining a comparison difference, and performing position compensation on the galvanometer based on the comparison difference.

7. The laser cleaning method for multiple tabs according to claim 6, wherein the single frame corresponding to the galvanometer meets the third error requirement comprises:
a difference between the actual coordinate position of the each segmentation point and the theoretical coordinate position of the each segmentation point is less than 0.03 mm.

8. The laser cleaning method for multiple tabs according to claim 1, wherein the splicing the multiple single frames corresponding to the multiple galvanometers into the entire frame corresponding to the galvanometer array comprises:
starting from a first single frame and a second single frame, taking a former single frame of each adjacent two single frames as a reference, performing frame translation and frame rotation on a latter single frame, so that the latter single frame and the former single frame are parallel and have the overlapping edges.

9. The laser cleaning method for multiple tabs according to claim 1, wherein the normalizing the single frame coordinate system corresponding to the each single frame into the entire frame coordinate system corresponding to the entire frame comprises:
making two coordinate axes of the single frame coordinate system corresponding to the each single frame correspond and overlap with each other.

10. The laser cleaning method for multiple tabs according to claim 1, wherein the laser cleaning device is provided with edge-finding sensors at a front side of a laser cleaning station and a rear side of the laser cleaning station, and the obtaining the offset information of the material strip edge of the material strip passing through the laser cleaning device relative to the material strip travel direction comprises:
obtaining a front side deviation amount of the material strip edge at the front side of the laser cleaning station and a rear side deviation amount of the material strip edge at the rear side of the laser cleaning station respectively by the edge-finding sensors at the front side of the laser cleaning station and the rear side of the laser cleaning station; and
obtaining the offset information based on the front side deviation amount and the rear side deviation amount.
